(19) United States
(12) Patent Application Publication
(10) Pub. No.: US 2015/0347042 A1
(43) Pub. Date: Dec. 3, 2015

(54) APPARATUS AND METHOD FOR CONTROLLING MEMORY

(71) Applicant: Electronics and Telecommunications Research Institute, Daejeon (KR)

(72) Inventors: Byoung-Seob KIM, Sejong (KR); Seung-Jo BAE, Daejeon (KR); Hyun-Hwa CHOI, Daejeon (KR)

(21) Appl. No.: 14/693,807

(22) Filed: Apr. 22, 2015

(30) Foreign Application Priority Data
May 30, 2014 (KR) 10-2014-0066373

(51) Int. Cl. G06F 3/06; G06F 12/10

(52) U.S. Cl. CPC G06F 3/0617; G06F 12/10; G06F 3/0644; G06F 3/0673; G06F 2212/1008; G06F 2212/152

(57) ABSTRACT

An apparatus for controlling memory according to an embodiment of the present invention comprises: a secondary storage device configured to store page-level data; a memory configured to store page information; and a processor configured to perform swap-out to modify the page information and load access target data in an unassigned area of the memory when a page fault for the access target data of the data is caused and capacity of the memory to load the access target data is insufficient.

### CROSS REFERENCE TO RELATED APPLICATION

This application claims the benefit of Korean Patent Application No. 10-2014-0066373, filed on May 30, 2014, entitled “Apparatus and method for controlling memory”, which is hereby incorporated by reference in its entirety into this application.

### BACKGROUND OF THE INVENTION

1. Technical Field

The present invention relates to a technology for controlling memory and more particularly to a technology for controlling memory using memory paging.

2. Description of the Related Art

Data generations such as sensor data, weblog, SNS data and space, weather and genome are recently increasing exponentially and demand on high speed processing for such large data is also increasing to extract and use desired information from the large data for services. Currently, capacity of a main memory of a computer cannot keep up with capacity of a secondary storage device such as HDD and SDD due to costs and technical limitations. Thus, efforts such as use of virtual memory addresses, demand paging and swap functions have been tried to overcome the limitation of memory capacity. However, such demand paging and swap mechanisms to overcome the capacity cannot avoid performance degradation factors such as memory reallocation or swap-in/swap-out.

### SUMMARY OF THE INVENTION

An object of the present invention is to provide an apparatus for controlling memory which can store data through a secondary storage device, which replaces a file system, and use data stored in the secondary storage device by loading in a memory and, thus, does not require to transmit data to be swapped from the memory to a storing medium during the page swapping process.

According to an aspect of the present invention, there is provided an apparatus for controlling memory comprising: a secondary storage device configured to store page-level data; a memory configured to store page information; and a processor configured to perform swap-out to modify the page information and load access target data in an unassigned area of the memory when a page fault for the access target data of the data is caused and capacity of the memory to load the access target data is insufficient.

The processor may perform to swap-out to eliminate a virtual address of the page corresponding to the access target data from the page information when a page fault for the access target data of the data is caused and capacity of the memory to load the access target data is insufficient

The page information may be mapped information of each page of the memory and virtual address of the data.

The processor may load the page corresponding to the access target data in an unassigned area of the memory

The apparatus for controlling memory may further comprise a communication interface configured to receive data from another device, wherein the processor may divide the data into page-levels to store in the secondary storage device.

The secondary storage device may include at least one of a hard disk and a flash memory.

According to another aspect of the present invention, there is provided a method for controlling memory, wherein an apparatus for controlling memory controls the memory, the method comprising: storing page-level data in a secondary storage device; performing swap-out to modify page information when a page fault for the access target data of the data is caused and capacity of the memory to load the access target data is insufficient; and loading the access target data stored in the secondary storage device in an unassigned area of the memory.

The step for performing swap-out to modify page information when a page fault for the access target data of the data is caused and capacity of the memory to load the access target data is insufficient, may comprise performing swap-out to eliminate a virtual address of the page corresponding to the access target data from the page information.

The page information may be mapped information of each page of the memory and virtual address of the data.

The step for loading the access target data stored in the secondary storage device in an unassigned area of the memory may comprise loading the page corresponding to the access target data in an unassigned area of the memory.

According to an embodiment of the present invention, it allows reducing resources which are required during a swapping process by reducing the incidence of transmitting data to be swapped from a memory to a secondary storage device during the page swapping process.

According to an embodiment of the present invention, it also allows preventing from storing data doubly both in a general file system and in a swap area which wastes a storing space.

### BRIEF DESCRIPTION OF DRAWING

FIG. 1 is a block view illustrating an apparatus for controlling memory according to an embodiment of the present invention.

FIG. 2 is a flowchart illustrating a method for controlling a memory with an apparatus for controlling memory according to an embodiment of the present invention.

FIG. 3 is a schematic view illustrating a method for controlling a memory with an apparatus for controlling memory according to an embodiment of the present invention.

### DESCRIPTION OF THE EXEMPLARY EMBODIMENTS

The present invention will be described with reference to particular embodiments, it is however to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted. While such terms as “first” and “second,” etc., may be used to describe various components, such components must not be limited to the above terms. The above terms are used only to distinguish one component from another.

When one element is described as being “connected” or “accessed” to another element, it shall be construed as being connected or accessed to the other element directly but also as possibly having another element in between.

Hereinafter, certain embodiments of the present invention will be described with reference to the accompanying drawings, in which those components are rendered the same reference number that are the same or are in correspondence, regardless of the figure number, and redundant explanations are omitted.

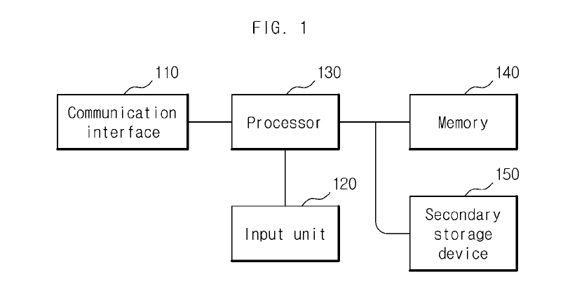

FIG. 1 is a block view illustrating an apparatus for controlling memory according to an embodiment of the present invention.

Referring to FIG. 1, an apparatus for controlling memory according to an embodiment of the present invention includes a communication interface 110, an input unit 120, a processor 130, a memory 140, and a secondary storage device 150.

The communication interface 110 receives data by being connected with another device such as a terminal, a portable storing medium and the like through a communication network or a predetermined terminal. The received data may be stored in the secondary storage device 150 in page-levels by the processor 130. Here, a virtual address for each page of the data may be assigned and the assigned virtual address may be stored in the memory 140.

The input unit 120 receives an executing instruction of the application which accesses data from a user.

The processor 130 receives an executing instruction of the application from the input unit 120, executes the application corresponding to the executing instruction, and tries to access for data according to the application to the memory 140. The processor 130 may perform swap-out to modify page information, load the data stored in the secondary storage device 150 at an unassigned area of the memory 140, and perform the application by accessing to the data when the data is not loaded in the memory 140.

When the data is received through the communication interface 110, the processor 130 divides the data into page-levels and stores the result in the secondary storage device 150.

The memory 140, which is a main storage device such as a volatile memory (RAM), loads the data stored in the secondary storage device 150 in page-levels and provides the loaded data to the processor 130.

The secondary storage device 150 is a storage device such as hard disk, flash memory and the like and stores page-level data. The processor 130 transmits the data stored in the secondary storage device 150 to the memory 140 to be loaded in the memory 140.

The apparatus for controlling memory stores all data by page-levels in the secondary storage device 150 without using a separate file system and loads the data stored in the secondary storage device 150 directly to the memory 140 when data is not loaded in the memory (when a page fault is caused). When a page fault is caused and capacity of the memory 140 to load access target data is insufficient and the page including the target data to be swapped is not a dirty page during the swap-out process, the apparatus for controlling memory does not perform the process of storing the data in a swap storage area of the secondary storage device 150 but modifies page information to show that the data is swapped-out. Here, the page information is information mapped with a virtual address corresponding to each page of the memory 140, and the processor 130 performs a swap-out process to eliminate the virtual address, which corresponds to the page of the data, from the page information. The apparatus for controlling memory performs the swap-out process to update the page information but does not store the data in the swap storage area which is separately formed in the secondary storage device. Accordingly, the apparatus for controlling memory can reduce delay time caused with the swap-out process.

When the page including the target data to be swapped is a dirty page during the swap-out process, the apparatus for controlling memory transmits the page including modified data to the secondary storage device 150 and updates the page information to show that the data is swapped-out.

The apparatus for controlling memory according to an embodiment of the present invention does not require data transmission between the memory 140 and the secondary storage device 150 during the swap-out process, except when it is a dirty page. Hereinafter, a process for controlling the memory 140 by the apparatus for controlling memory according to an embodiment of the present invention will be described in detail.

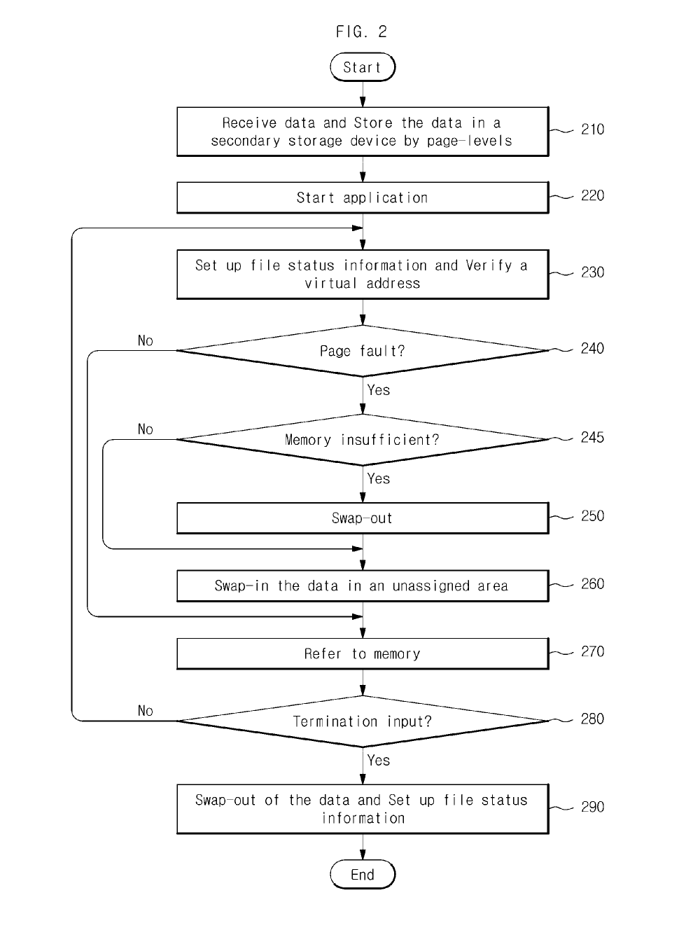

A process for controlling a memory by loading data in the memory by the apparatus for controlling memory will be described with reference to the accompanying FIG. 2.

FIG. 2 is a flowchart illustrating a method for controlling a memory with an apparatus for controlling memory according to an embodiment of the present invention.

Referring to FIG. 2, in Step 210, the apparatus for controlling memory receives data from another device and stores the data in a secondary storage device by page-levels.

In Step 220, the apparatus for controlling memory receives an executing instruction of an application through the input unit 120.

In Step 230, the apparatus for controlling memory sets up current status of a file corresponding to the application according to the executing instruction of the application to indicate that the file is opened, and verifies a virtual address of the file. Here, the file status information may be information to indicate that each file is opened or closed.

In Step 240, the apparatus for controlling memory determines whether an address of the memory 140 for the virtual address is mapped from the page information. For example, when an address of the memory 140 for the virtual address is not mapped from the page information, the apparatus for controlling memory determines as that a page fault is caused. On the other hand, when an address of the memory 140 for the virtual address is mapped from the page information, it determines as that a page fault is not caused.

In Step 250, when a page fault is caused in Step 240, the apparatus for controlling memory determines whether space to store current data in the memory 140 is sufficient or not. When the space is not sufficient in Step 245, the apparatus for controlling memory performs swap-out in Step 250. For example, the apparatus for controlling memory performs swap-out for the page among pages currently assigned in the memory 140 which satisfies a predetermined condition. Here, the apparatus for controlling memory may perform swap-out to eliminate a virtual address for the page which satisfies the predetermined condition. Here, the apparatus for controlling memory may further perform a swap-out process to update the page stored in the secondary storage device 150 based on the page stored in the memory 140 when the page is modified in the memory 140 (when the page to be swapped-out is a dirty page). The apparatus for controlling memory then performs Step 260.

When the space to store current data in the memory 140 is sufficient in Step 245, the apparatus for controlling memory performs swap-in for the data in an unassigned page in Step 260. For example, the apparatus for controlling memory loads the page of the data stored in the secondary storage device 150 in the unassigned page of the memory 140. When the page fault is not caused in Step 240, the apparatus for controlling memory refers to the data loaded in the memory 140 in Step 270.

In Step 280, the apparatus for controlling memory determines whether a termination instruction to request for terminating the application is received through the input unit 120.

When the termination instruction is received in Step 280, in Step 290, the apparatus for controlling memory swaps-out the data of the file corresponding to the application and sets up the file status information to indicate that the file is closed. Here, the apparatus for controlling memory may further perform a swap-out process to update the page stored in the secondary storage device 150 based on the page stored in the memory 140 when the page of the memory 140 to be swapped-out is modified (when the page to be swapped-out is a dirty page).

When the termination instruction is not received in Step 280, the apparatus for controlling memory performs again the process from Step 230 for a new file according to an access request to the new file by the application.

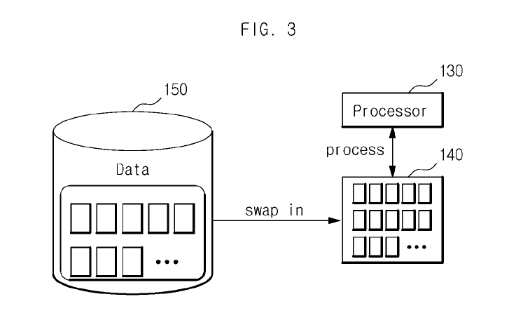

FIG. 3 is a schematic view illustrating a method for controlling a memory with an apparatus for controlling memory according to an embodiment of the present invention.

Referring to FIG. 3, the apparatus for controlling memory stores data by page-levels in the secondary storage device 150 when the data is received. Here, when the processor 130 tries to access to the data to the memory 140 according to the execution of an application, the processor 130 performs a swap-out process to modify page information stored in the memory 140. That is, since the apparatus for controlling memory stores all the data in the secondary storage device 150 by page-levels, it does not require to store the data to be swapped-out again in the secondary storage device 150.

When the page including the target data to be swapped-out is not a dirty page, the processor 130 completes the swap-out process by modifying the page information and immediately performs the swap-in process to load the page stored in the secondary storage device 150 to the memory 140. Since the secondary storage device 150 stores the data by page-levels, it is not necessary to divide the data to load in the memory 140 during the swap-in process.

Therefore, when a page fault is caused, the apparatus for controlling memory according to an embodiment of the present invention shortens the time taken for the swap-out and swap-in processes. This further allows fast access to each data in the process referring to large data. A conventional virtual memory system must perform the process to store data in a swap area (a separate storage area storing data to be swapped-out) during the swap-out process, while the apparatus for controlling memory according to an embodiment of the present invention does not require any transmission nor recording of data to the secondary storage device 150 during the swap-out process so that the swap-out process can be simplified.

The apparatus for controlling memory according to an embodiment of the present invention can also prevent from storing data doubly both in a general file system and in a swap area which wastes a storing space.

In a case for referring to large data, the apparatus for controlling memory according to an embodiment of the present invention can significantly save resources required for the swap-out process since the swap-out occurs frequently.

The computer readable medium may include a program instruction, a data file and a data structure or a combination of one or more of these. The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. An apparatus for controlling memory comprising:
a secondary storage device configured to store page-level data;
a memory configured to store page information; and
a processor configured to perform swap-out to modify the page information and load access target data in an unassigned area of the memory when a page fault for the access target data of the data is caused and capacity of the memory to load the access target data is insufficient.

2. The apparatus for controlling memory of claim 1, wherein the processor performs to swap-out to eliminate a virtual address of the page corresponding to the access target data from the page information when a page fault for the access target data of the data is caused and capacity of the memory to load the access target data is insufficient.

3. The apparatus for controlling memory of claim 2, wherein the page information is mapped information of each page of the memory and virtual address of the data.

4. The apparatus for controlling memory of claim 1, wherein the processor loads the page corresponding to the access target data in an unassigned area of the memory.

5. The apparatus for controlling memory of claim 1, further comprising a communication interface configured to receive data from another device,
wherein the processor divides the data into page-levels to store in the secondary storage device.

6. The apparatus for controlling memory of claim 1, wherein the secondary storage device is at least one of a hard disk and a flash memory.

7. A method for controlling memory by an apparatus for controlling memory, the method comprising:
storing page-level data in a secondary storage device;
performing swap-out to modify page information when a page fault for the access target data of the data is caused and capacity of the memory to load the access target data is insufficient; and
loading the access target data stored in the secondary storage device in an unassigned area of the memory.

8. The method for controlling memory of claim 7, wherein the step for performing swap-out to modify page information when a page fault for the access target data of the data is caused and capacity of the memory to load the access target data is insufficient, comprises performing swap-out to eliminate a virtual address of the page corresponding to the access target data from the page information.

9. The method for controlling memory of claim 8, wherein the page information is mapped information of each page of the memory and virtual address of the data.

10. The method for controlling memory of claim 7, wherein the step for loading the access target data stored in the secondary storage device in an unassigned area of the memory comprises loading the page corresponding to the access target data in an unassigned area of the memory.

11. The method for controlling memory of claim 7, further comprising receiving the data from another device,
wherein the step for storing page-level data in a secondary storage device comprises for a processor dividing the data into page levels to store in the secondary storage device.
